(19) United States
(12) Patent Application Publication
(10) Pub. No.: US 2026/0336618 A1
(43) Pub. Date: Oct. 29, 2026

(54) PREDICTION TIME DETERMINATION METHOD, APPARATUS AND DEVICE FOR ADJUSTING VEHICLE-FOLLOWING STATE

(71) Applicant: Rox Motor Tech Co., Ltd, Shanghai (CN)

(72) Inventors: Chunlei ZHANG, Shanghai (CN); Zhenlei Song, Shanghai (CN); Jiahou Peng, Shanghai (CN)

(73) Assignee: Rox Motor Tech Co., Ltd, Shanghai (CN)

(21) Appl. No.: 19/117,969

(22) PCT Filed: Apr. 24, 2023
(86) PCT No.: PCT/CN2023/090403

§ 371 Date: Apr. 3, 2025

(30) Foreign Application Priority Data
Oct. 18, 2022 (CN) 202211273976.7
Oct. 18, 2022 (CN) 202211274805.6

(51) Int. Cl. B60W 30/16; B60W 40/105; B60W 40/107; B60W 50/00

(52) U.S. Cl. CPC B60W 30/16; B60W 40/105; B60W 40/107; B60W 50/0097; B60W 2050/0022; B60W 2520/10; B60W 2554/4041; B60W 2554/802; B60W 2554/804; B60W 2720/10; B60W 2720/106; B60W 2754/30

(57) ABSTRACT

A prediction time determination method for adjusting a vehicle-following state. The method comprises: acquiring a desired vehicle-following distance, a first traveling speed, a second traveling speed, and a vehicle distance between a first vehicle and a second vehicle (S101); determining a target speed parameter according to the first traveling speed and the second traveling speed (S102); determining a target distance parameter according to the desired vehicle-following distance and the vehicle distance (S103); and determining a prediction time according to the target speed parameter and the target distance parameter (S104). A prediction time is determined according to a target speed parameter and a target distance parameter, the target speed parameter is determined according to a first traveling speed and a second traveling speed, and the target distance parameter is determined according to a desired vehicle-following distance and a vehicle distance, thereby improving the user experience and safety.

### CROSS-REFERENCE TO RELATED APPLICATIONS

The present application is a national stage of International Application No. PCT/CN2023/090403 filed on Apr. 24, 2023, which claims the priority to Chinese Patent Application No. 202211274805.6 filed on Oct. 18, 2022, and Chinese Patent Application No. 202211273976.7 filed on Oct. 18, 2022, all of which are incorporated herein by reference in their entireties.

### TECHNICAL FIELD

The present application relates to the technical field of vehicle control, and in particular to a prediction time determination method for adjusting vehicle-following state, apparatus and device.

### BACKGROUND

With the vigorous development of various technologies in the field of autonomous driving, people are increasingly relying on the adaptive cruise control system of vehicles. When a vehicle is following a preceding vehicle, the adaptive cruise control system needs to control a distance between the vehicle and the preceding vehicle to be greater than a safe distance.

When the distance between the vehicle and the preceding vehicle is too small, there is a potential safety hazard. Therefore, the adaptive cruise control system needs to adjust the vehicle-following state. In general, the adaptive cruise control system needs to complete the adjustment of the vehicle-following state within a preset prediction time.

### SUMMARY

In a first aspect, an embodiment of the present application provides a prediction time determination method for adjusting a vehicle-following state, the method comprises: acquiring a desired vehicle-following distance, a first traveling speed of the first vehicle, a second traveling speed of a second vehicle, and a vehicle distance between the first vehicle and the second vehicle, wherein the first vehicle and the second vehicle travel in a same lane, and the first vehicle travels behind the second vehicle; determining a target speed parameter according to the first traveling speed and the second traveling speed; determining a target distance parameter according to the desired vehicle-following distance and the vehicle distance; and determining a prediction time according to the target speed parameter and the target distance parameter.

Optionally, the step of determining a target speed parameter according to the first traveling speed and the second traveling speed specifically comprises: determining a relative speed according to the first traveling speed and the second traveling speed; and calculating a ratio of the relative speed to the first traveling speed to obtain the target speed parameter.

Optionally, the step of determining a target distance parameter according to the desired vehicle-following distance and the vehicle distance specifically comprises: determining a relative distance according to the desired vehicle-following distance and the vehicle distance; and calculating a ratio of the vehicle distance to the desired vehicle-following distance to obtain the target distance parameter.

Optionally, the step of determining a prediction time according to the target speed parameter and the target distance parameter specifically comprises: determining an initial prediction time according to the target speed parameter and the target distance parameter; and correcting the initial prediction time to obtain the prediction time.

Optionally, the step of correcting the initial prediction time to obtain the prediction time specifically comprises: acquiring a maximum prediction time and a minimum prediction time of the first vehicle; determining an intermediate prediction time according to the minimum prediction time and the initial prediction time; and determining a smaller one of the intermediate prediction time and the maximum prediction time as the prediction time.

Optionally, the step of determining an intermediate prediction time according to the minimum prediction time and the initial prediction time specifically comprises: acquiring a preset weight parameter; determining a product of the minimum prediction time and the weight parameter as a weighted value; and determining a sum of the weighted value and the initial prediction time as the intermediate prediction time.

Optionally, after the step of determining a prediction time according to the target speed parameter and the target distance parameter, the method further comprises: acquiring a prediction period, a prediction time, a first traveling speed of the first vehicle, a second traveling speed of a second vehicle, a desired vehicle-following distance, and a vehicle distance between the first vehicle and the second vehicle; determining a minimum acceleration within the prediction time according to the prediction time, the first traveling speed, the second traveling speed, the desired vehicle-following distance, and the vehicle distance; and traveling according to the minimum acceleration and adjusting the vehicle-following state in the prediction period.

Optionally, after the step of adjusting the vehicle-following state, the method further comprises: acquiring a first traveling speed, a second traveling speed, a desired vehicle-following distance, and a vehicle distance; and returning back to the step of acquiring a prediction period, a prediction time, a first traveling speed of the first vehicle, a second traveling speed of a second vehicle, a desired vehicle-following distance, and a vehicle distance between the first vehicle and the second vehicle when it is determined that a vehicle-following condition is not satisfied according to the first traveling speed, the second traveling speed, the desired vehicle-following distance, and the vehicle distance.

Optionally, the vehicle-following condition comprises: the first traveling speed being equal to the second traveling speed, and the desired vehicle-following distance being equal to the vehicle distance.

Optionally, the step of determining a minimum acceleration within the prediction time according to the prediction time, the first traveling speed, the second traveling speed, the desired vehicle-following distance, and the vehicle distance specifically comprises: dividing the prediction time into several prediction sub-times; determining sub-accelerations corresponding to the several prediction sub-times respectively according to the prediction time, the first traveling speed, the second traveling speed, the desired vehicle-following distance, and the vehicle distance; and determining a smallest sub-acceleration among several sub-accelerations as the minimum acceleration within the prediction time.

Optionally, the several prediction sub-times are all equal to each other in duration.

Optionally, the step of determining sub-accelerations corresponding to the several prediction sub-times respectively according to the prediction time, the first traveling speed, the second traveling speed, the desired vehicle-following distance, and the vehicle distance specifically comprises: determining a prediction acceleration curve corresponding to the prediction time according to the prediction time, the first traveling speed, the second traveling speed, the desired vehicle-following distance, and the vehicle distance; determining, for each of the prediction sub-times, a sub-acceleration curve of the prediction acceleration curve corresponding to the prediction sub-time; and determining a minimum value of the sub-acceleration curve as the sub-acceleration corresponding to the prediction sub-time.

In a second aspect, an embodiment of the present application provides a prediction time determination apparatus for adjusting a vehicle-following state, the apparatus comprises: an acquisition unit, configured to acquire a desired vehicle-following distance, a first traveling speed of the first vehicle, a second traveling speed of a second vehicle, and a vehicle distance between the first vehicle and the second vehicle, wherein the first vehicle and the second vehicle travel in a same lane, and the first vehicle travels behind the second vehicle; a first determination unit, configured to determine a target speed parameter according to the first traveling speed and the second traveling speed; a second determination unit, configured to determine a target distance parameter according to the desired vehicle-following distance and the vehicle distance; and a prediction time unit, configured to determine a prediction time according to the target speed parameter and the target distance parameter.

In a third aspect, an embodiment of the present application provides a prediction time determination device for adjusting a vehicle-following state, the device comprising: a processor and a memory storing computer program instructions, wherein the computer program instructions, when executed by the processor, implement the prediction time determination method for adjusting a vehicle-following state according to the first aspect.

In a fourth aspect, an embodiment of the present application provides a computer readable storage medium having stored thereon computer program instructions which, when executed by a processor, implement the prediction time determination method for adjusting a vehicle-following state according to the first aspect.

In a fifth aspect, an embodiment of the present application provides a computer program product, wherein when instructions in the computer program product are executed by a processor of an electronic device, enables the electronic device to implement the prediction time determination method for adjusting a vehicle-following state according to the first aspect.

### BRIEF DESCRIPTION OF THE DRAWINGS

In order to explain the technical solutions of the embodiments of the present application more clearly, a brief introduction to the accompanying drawings for the embodiments of this application will be provided below. For a person skilled in the art, additional drawings can be derived from these drawings without the need for inventive effort.

FIG. 1 shows a flow chart of a prediction time determination method for adjusting a vehicle-following state according to an embodiment of the present application;

FIG. 2 shows a flow chart of a prediction time determination method for adjusting a vehicle-following state according to another embodiment of the present application;

FIG. 3 shows a flow chart of a method for adjusting a vehicle-following state according to an embodiment of the present application;

FIG. 4 shows a flow chart of a method for adjusting a vehicle-following state according to another embodiment of the present application;

FIG. 5 shows a schematic structural view of a prediction time determination apparatus for adjusting a vehicle-following state according to an embodiment of the present application; and

FIG. 6 shows a schematic structural view of a prediction time determination device for adjusting a vehicle-following state according to an embodiment of the present application.

### DETAILED DESCRIPTION

Features and exemplary embodiments of various aspects of the present application will be described in detail below. In order to make the objects, technical solutions and advantages of the present application clear, the present application will be further described in detail below with reference to the drawings and specific embodiments. It should be understood that the specific embodiments described herein are only intended to explain the present application, but not to limit the present application. For those of ordinary skilled in the art, the present application may be implemented without some of those specific details. The following description of the embodiments is only for providing a better understanding of the present application by showing examples of the present application.

It should be noted that, relational terms such as first, second, and the like are used herein merely to distinguish one entity or operation from another without necessarily requiring or implying any such actual relationship or order between such entities or operations. Moreover, the terms “include”, “including”, or any other variation thereof, are intended to cover a non-exclusive inclusion, such that a(n) process, method, article or device that includes a series of elements not only includes those elements but also includes other elements not explicitly listed or also includes elements inherent to such process, method, article or device. An element preceded by “include . . . ” does not, without more constraints, preclude the existence of additional identical elements in the process, method, article or device that includes the element.

Normally, when following a preceding vehicle, a vehicle activating the adaptive cruise control system needs to keep a certain distance from the preceding vehicle to reduce the possibility of rear-end collision. When the vehicle is too close to the preceding vehicle, it is necessary to adjust the vehicle-following state to ensure traveling safety. Moreover, since the road conditions change rapidly while the vehicle is traveling, a fixed prediction time is usually set in advance, and the adjustment of vehicle state should be completed within the prediction time to ensure traveling safety and adjust the vehicle-following state as soon as possible.

In addition, when a distance between the vehicle and the preceding vehicle is too small, the adaptive cruise control system may reverse to quickly increase the distance and ensure that the distance between the vehicles is equal to the safe distance within the prediction time. For example, a first vehicle and a second vehicle travel in a same lane, the first vehicle travels behind the second vehicle, the vehicle distance between the first vehicle and the second vehicle is 10 meters (m), the traveling speed of the second vehicle is 20 kilometers per hour (km/h), the traveling speed of the first vehicle is 50 km/h, the prediction time is 5 seconds (s), and the safe distance is 30 m. The first vehicle takes 2 s to decelerate, and the traveling speed decreases to 0 km/h. At this time, the vehicle distance is 10 m. Even if the first vehicle is stationary in the remaining 3 s, the traveling distance of the second vehicle within 3 s is about 17 m, the vehicle distance after 3 s is 27 m, and the vehicle distance is still less than the safe distance, i.e., 30 m, when the prediction time is reached. Therefore, the adaptive cruise control system of the first vehicle may control the first vehicle to reverse, thereby increasing the distance between the first vehicle and the second vehicle. However, reversing on the road will lead to great potential safety hazards, and may violate traffic rules and reduce the user experience. Therefore, the present application discloses a method for adjusting a vehicle-following state.

The safe distance refers to the necessary distance that a rear vehicle keeps from a preceding vehicle during traveling to avoid accidental collision with the preceding vehicle. The safe distance is usually determined according to the speed of the vehicles. When the vehicle is traveling at a high speed, that is, when the traveling speed is greater than or equal to 100 kilometers per hour (km/h), the safe distance is greater than or equal to 100 meters (m); or when the vehicle is traveling at a fast speed, that is, the traveling speed is greater than or equal to 60 kilometers per hour (km/h), the safe distance is equal to an absolute value of the traveling speed (with unit m). In the above example, since the first vehicle follows the second vehicle after the prediction time, the traveling speed of the first vehicle should be the same as the traveling speed of the second vehicle. Then, the adaptive cruise control system of the first vehicle determines that the safe distance is 30 m based on the traveling speed of the second vehicle of 20 km/h.

However, since the distance between the vehicle and the preceding vehicle may be relatively small during following travel process, in this case, the vehicle usually greatly accelerates/decelerates in a short time to ensure that the adjustment of vehicle-following state can be completed within the adjustment time, which will reduce user experience. In addition, if the vehicle performs the operation of greatly accelerating/decelerating in a short time during travel, it will lead to potential safety hazard. Embodiments of the present application provide a prediction time determination method for adjusting a vehicle-following state, apparatus, device, and computer storage medium to solve the problems in the prior art. The prediction time determination method for adjusting a vehicle-following state according to an embodiment of the present application will be described below.

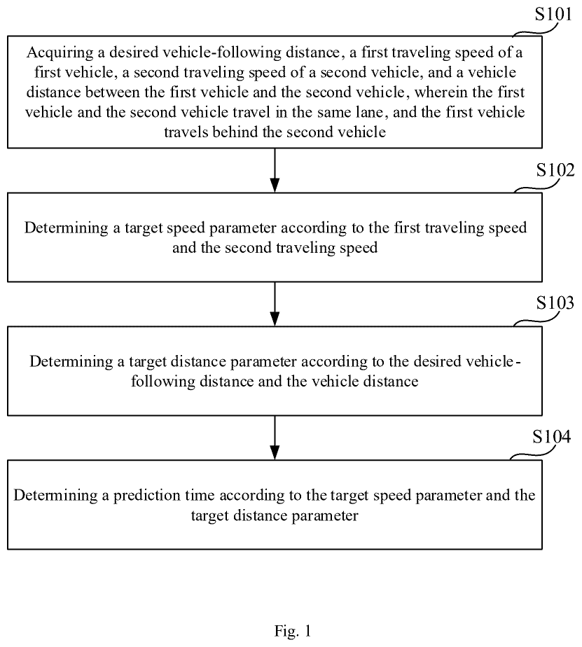

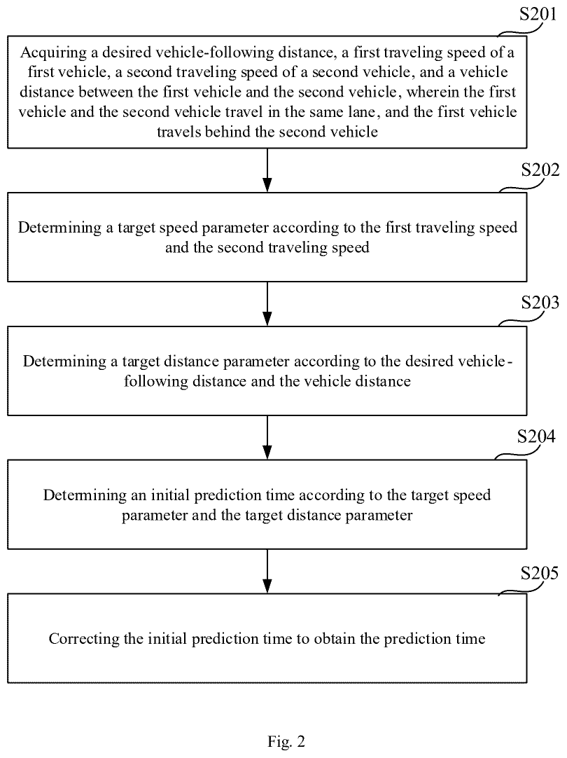

FIG. 1 is a flow chart of a prediction time determination method for adjusting a vehicle-following state according to an embodiment of the present application. As shown in FIG. 1, the prediction time determination method for adjusting the vehicle-following state according to an embodiment of the present application includes the following steps: S101 to S104.

In S101, a desired vehicle-following distance, a first traveling speed of the first vehicle, a second traveling speed of a second vehicle, and a vehicle distance between the first vehicle and the second vehicle are acquired, wherein the first vehicle and the second vehicle travel in a same lane, and the first vehicle travels behind the second vehicle.

In the present application, the prediction time determination method for adjusting a vehicle-following state may be executed by a vehicle control center of the first vehicle, or may be executed by a device such as a cloud server connected to the first vehicle. The device executing the aforesaid method may be set as necessary and is not limited in the present application. In one or more embodiments of the present application, for convenience of description, the prediction time determination method for adjusting the vehicle-following state is described in detail by taking the method being executed by the vehicle control center as an example.

When following a preceding vehicle, the vehicle needs to keep a safe distance from the preceding vehicle. That is, the distance between the vehicle and the preceding vehicle is equal to the safe distance. For example, when the vehicle is traveling at a high speed, i.e., when the traveling speed is greater than or equal to 100 kilometers per hour (km/h), the safe distance is greater than or equal to 100 meters (m). Alternatively, when the vehicle is traveling at a fast speed, that is, the traveling speed is greater than or equal to 60 kilometers per hour (km/h), the safe distance is equal to an absolute value of the traveling speed (in units of m).

Normally, when the speed of the vehicle is the same as the speed of the preceding vehicle, and the difference between the vehicle distance and the safe distance is small, the vehicle-following state can be adjusted in a short time to ensure that the vehicle distance is the same as the safe distance. However, if the speed of the vehicle is the same as the speed of the preceding vehicle, and the difference between the vehicle distance and the safe distance is large, it will take a long time to adjust the vehicle-following state to ensure that the vehicle distance is the same as the safe distance.

For example, a first vehicle and a second vehicle travel in a same lane, the first vehicle travels behind the second vehicle, the traveling speeds of the first vehicle and the second vehicle each are 100 km/h, the vehicle distance between the first vehicle and the second vehicle is 10 m, and the safe distance is 100 m. The first vehicle takes 10 seconds (s) to adjust the vehicle-following state to ensure that the distance between the first vehicle and the second vehicle is equal to the safe distance. For another example, a third vehicle and a fourth vehicle travel in a same lane, the third vehicle travels behind the fourth vehicle, the traveling speeds of the third vehicle and the fourth vehicle each are 100 km/h, the vehicle distance between the third vehicle and the fourth vehicle is 90 m, and the safe distance is 100 m. The third vehicle only needs 3 seconds (s) to adjust the vehicle-following state to ensure that the distance between the third vehicle and the fourth vehicle is equal to the safe distance.

Moreover, normally, when the speed difference between the vehicle and the preceding vehicle is relatively small, and the vehicle distance is equal to the safe distance, the vehicle-following state can be adjusted in a short time to ensure that the vehicle distance is equal to the safe distance, and the speed of the vehicle is equal to the speed of the preceding vehicle. However, if the speed difference between the vehicle and the preceding vehicle is large, and the vehicle distance is equal to the safe distance, it takes a relatively long time to adjust the vehicle-following state to ensure that the vehicle distance is equal to the safe distance, and the speed of the vehicle is equal to the speed of the preceding vehicle.

For example a fifth vehicle and a sixth vehicle travel in a same lane, the fifth vehicle travels behind the sixth vehicle, the traveling speed of the fifth vehicle is 120 km/h, the traveling speed of the sixth vehicle is 80 km/h, the vehicle distance between the fifth vehicle and the sixth vehicle is 100 m, and the safe distance is 100 m. The fifth vehicle needs 10 seconds (s) to adjust the vehicle-following state, so as to ensure that the traveling speed of the fifth vehicle is equal to the traveling speed of the sixth vehicle, and the distance between the fifth vehicle and the sixth vehicle is equal to the safe distance. For another example, a seventh vehicle and a eighth vehicle travel in a same lane, the seventh vehicle travels behind the eighth vehicle, the traveling speed of the seventh vehicle is 81 km/h, the traveling speed of the eighth vehicle is 80 km/h, the vehicle distance between the seventh vehicle and the eighth vehicle is 100 m, and the safe distance is 100 m. The seventh vehicle only needs 3 seconds (s) to adjust the vehicle-following state to ensure that the traveling speed of the seventh vehicle is equal to the traveling speed of the eighth vehicle, and the distance between the seventh vehicle and the eighth vehicle is equal to the safe distance.

Therefore, in one or more embodiments of the present application, for determining the prediction time for adjusting the vehicle-following state more accurately, improving the user experience, and reducing potential safety hazards, data such as a first traveling speed and a second traveling speed may be acquired to determine the prediction time for adjusting the vehicle-following state.

Specifically, the vehicle control center may acquire a first traveling speed of the first vehicle, a second traveling speed of the second vehicle, a vehicle distance between the first vehicle and the second vehicle, and a desired vehicle-following distance. The vehicle control center is disposed in the first vehicle, the first vehicle and the second vehicle travel in the same lane, and the first vehicle travels behind the second vehicle.

It should be noted that, the first traveling speed of the first vehicle may be acquired by a speed sensor disposed in the first vehicle. The second traveling speed of the second vehicle and the vehicle distance between the first vehicle and the second vehicle may be acquired by a device such as a radar or an image sensor disposed in the first vehicle. The specific device acquiring the first traveling speed, the second traveling speed, and the vehicle distance between the first vehicle and the second vehicle may be set as necessary and is not limited in the present application. Further, the desired vehicle-following distance may be set in advance. For example, the desired vehicle-following distance may be set in advance to 50 m, 80 m, or 100 m. The safe distance corresponding to the second traveling speed may be set as the desired vehicle-following distance. For example, if the second traveling speed is 100 km/h and the corresponding safe distance is 100 m, then the desired vehicle-following distance is 100 m; or if the second traveling speed is 20 km/h and the corresponding safe distance is 30 m, then the desired vehicle-following distance is 30 m. The desired vehicle-following distance may be set as necessary and is not limited in the present application.

According to the above method, the vehicle control center may acquire data, such as the first traveling speed and the second traveling speed, to determine the prediction time for adjusting the vehicle-following state according to the data such as the first traveling speed and the second traveling speed, thereby improving safety and user experience.

In S102, a target speed parameter is determined according to the first traveling speed and the second traveling speed.

Normally, the longer the difference between the first traveling speed of the first vehicle and the second traveling speed of the second vehicle is, the longer the time required for adjusting the vehicle-following state will become. Still referring to the above example, the fifth vehicle and the sixth vehicle travel in a same lane, the fifth vehicle travels behind the sixth vehicle, the traveling speed of the fifth vehicle is 120 km/h, the traveling speed of the sixth vehicle is 80 km/h, the vehicle distance between the fifth vehicle and the sixth vehicle is 100 m, and the safe distance is 100 m. The fifth vehicle needs 10 seconds (s) to adjust the vehicle-following state to ensure that the traveling speed of the fifth vehicle is equal to the traveling speed of the sixth vehicle, and the distance between the fifth vehicle and the sixth vehicle is equal to the safe distance. Still referring to the above another example, the seventh vehicle and the eighth vehicle travel in a same lane, the seventh vehicle travels behind the eighth vehicle, the traveling speed of the seventh vehicle is 81 km/h, the traveling speed of the eighth vehicle is 80 km/h, the vehicle distance between the seventh vehicle and the eighth vehicle is 100 m, and the safe distance is 100 m. The seventh vehicle only needs 3 seconds (s) to adjust the vehicle-following state to ensure that the traveling speed of the seventh vehicle is equal to the traveling speed of the eighth vehicle, and the distance between the seventh vehicle and the eighth vehicle is equal to the safe distance.

Then, the vehicle control center may determine the target speed parameter for characterizing a difference between the first traveling speed and the second traveling speed.

Specifically, in one or more embodiments of the present application, the vehicle control center may determine the target speed parameter according to the first traveling speed and the second traveling speed. When determining the target speed parameter, the vehicle control center may determine the difference between the first traveling speed and the second traveling speed as a relative speed. Then, the vehicle control center calculates a ratio of the relative speed to the first traveling speed to obtain a target speed parameter. Alternatively, the vehicle control center may determine the difference between the first traveling speed and the second traveling speed as a relative speed. Then, the vehicle control center calculates a ratio of the relative speed to the second traveling speed to obtain the target speed parameter. Specifically, the target speed parameter may be determined as needed, and the present application does not limit it here.

In the above manner, the vehicle control center may determine the target speed parameter characterizing the difference between the first traveling speed and the second traveling speed to determine the prediction time for adjusting the vehicle-following state via the target speed parameter, thereby improving safety and user experience.

In S103, a target distance parameter is determined according to the desired vehicle-following distance and the vehicle distance.

Normally, the longer the distance between the first vehicle and the second vehicle is different from the desired vehicle-following distance, the longer the time required for adjusting the vehicle-following state will become. Still referring to the above example, it is assumed that, the first vehicle and the second vehicle travel in a same lane, the first vehicle travels behind the second vehicle, the traveling speeds of the first vehicle and the second vehicle are both 100 km/h, the vehicle distance between the first vehicle and the second vehicle is 10 m, and the safe distance is 100 m. The first vehicle takes 10 seconds (s) to adjust the vehicle-following state to ensure that the distance between the first vehicle and the second vehicle is equal to the safe distance. Still referring to the above another example, the third vehicle and the fourth vehicle travel in a same lane, the third vehicle travels behind the fourth vehicle, the traveling speeds of the third vehicle and the fourth vehicle are both 100 km/h, the vehicle distance between the third vehicle and the fourth vehicle is 90 m, and the safe distance is 100 m. The third vehicle only needs 3 seconds (s) to adjust the vehicle-following state to ensure that the distance between the third vehicle and the fourth vehicle is equal to the safe distance.

Therefore, the vehicle control center may determine a target distance parameter for characterizing the difference between the vehicle distance and the desired vehicle-following distance.

Specifically, in one or more embodiments of the present application, the vehicle control center may determine the target distance parameter according to the vehicle distance and the desired vehicle-following distance. When determining the target distance parameter, the vehicle control center may determine a difference between the vehicle distance and the desired vehicle-following distance as a relative distance, and then the vehicle control center calculates a ratio of the relative distance to the vehicle distance to obtain the target distance parameter; or the vehicle control center may determine a difference between the vehicle distance and the desired vehicle-following distance as a relative distance, and then the vehicle control center calculates a ratio of the relative distance to the desired vehicle-following distance to obtain the target distance parameter. Specifically, the target distance parameter may be determined as needed and is not limited by the present application.

In the above manner, the vehicle control center may determine the target distance parameter characterizing the difference between the vehicle distance and the desired vehicle-following distance to determine the prediction time for adjusting the vehicle-following state via the target distance parameter, thereby improving safety and user experience.

In S104, a prediction time is determined according to the target speed parameter and the target distance parameter.

In one or more embodiments of the present application, after the target speed parameter and the target distance parameter are determined, the prediction time for adjusting the vehicle-following state can be determined.

Specifically, in one or more embodiments of the present application, the vehicle control center may calculate the square of the target speed parameter to obtain a speed squared parameter, and the square of the target distance parameter to obtain a distance squared parameter; then a sum of the speed squared parameter and the distance squared parameter is calculated to obtain a squared parameter; and finally, the arithmetic square root of the squared parameter is calculated to obtain the prediction time (in units of s).

The above calculation process may be expressed by the following formula:

t=\sqrt{A²+B²}

wherein t is the prediction time, A is the target speed parameter, and B is the target distance parameter.

In the above manner, the vehicle control center may determine the prediction time for adjusting the vehicle-following state according to the target speed parameter and the target distance parameter, such that the vehicle control center controls the vehicle to travel within the prediction time and complete the vehicle-following state adjustment, which can balance safety and comfort, and improve safety and user experience.

The above is a specific implementation of the prediction time determination method for adjusting the vehicle-following state according to embodiments of the present application. It can be seen that, in embodiments of the present application, the prediction time is determined according to the target speed parameter and the target distance parameter, the target speed parameter is determined according to the first traveling speed of the first vehicle and the second traveling speed of the second vehicle followed by the first vehicle, and the target distance parameter is determined according to the desired vehicle-following distance and the vehicle distance. Thus, the prediction time is determined according to the traveling speed of the two vehicles, the desired vehicle-following distance and actual vehicle distance. The desired vehicle-following distance is related to safety, and the vehicle speed and distance are safety factors. Therefore, the prediction time obtained thereby can balance safety and comfort.

Since the road conditions change rapidly during the actual traveling process of the vehicle, the present application further provides another implementation of the prediction time determination method for adjusting the vehicle-following state (see the following embodiments for details) to timely adjust the vehicle-following state and improve safety.

In S201, a desired vehicle-following distance, a first traveling speed of the first vehicle, a second traveling speed of a second vehicle, and a vehicle distance between the first vehicle and the second vehicle are acquired, wherein the first vehicle and the second vehicle travel in a same lane, and the first vehicle travels behind the second vehicle.

In S202, a target speed parameter is determined according to the first traveling speed and the second traveling speed.

In S203, a target distance parameter is determined according to the desired vehicle-following distance and the vehicle distance.

In S204, an initial prediction time is determined according to the target speed parameter and the target distance parameter.

Specifically, in one or more embodiments of the present application, the vehicle control center may calculate the square of the target speed parameter to obtain a speed squared parameter, and the square of the target distance parameter to obtain a distance squared parameter; then the vehicle control center calculates a sum of the speed squared parameter and the distance squared parameter to obtain a squared parameter; and finally, the arithmetic square root of the squared parameter is calculated to obtain the initial prediction time (in units of s).

In S205, the initial prediction time is corrected to obtain the prediction time.

Specifically, the vehicle control center may correct the initial prediction time to obtain the prediction time.

The vehicle control center may acquire a preset maximum prediction time and a preset minimum prediction time of the first vehicle, wherein the minimum prediction time is less than the maximum prediction time. The vehicle control center then calculates a sum of the minimum prediction time and the initial prediction time to obtain an intermediate prediction time. Finally, the vehicle control center determines a smaller one of the intermediate prediction time and the maximum prediction time as the prediction time. That is, when it is determined that the intermediate prediction time is less than the maximum prediction time, the intermediate prediction time is determined as the prediction time. When it is determined that the intermediate prediction time is greater than the maximum prediction time, the maximum prediction time is determined as the prediction time. Of course, if the intermediate prediction time is equal to the maximum prediction time, the vehicle control center may determine the intermediate prediction time or the maximum prediction time as the prediction time.

Alternatively, the vehicle control center may acquire a preset maximum prediction time and a preset minimum prediction time of the first vehicle, wherein the minimum prediction time is less than the maximum prediction time. When it is determined that the initial prediction time is less than the minimum prediction time, the minimum prediction time is determined as the prediction time. When it is determined that the initial prediction time is greater than the maximum prediction time, the maximum prediction time is determined as the prediction time. When it is determined that the initial prediction time is greater than or equal to the minimum prediction time, and the initial prediction time is less than or equal to the maximum prediction time, the initial prediction time is determined as the prediction time.

Alternatively, the vehicle control center may acquire a preset maximum prediction time, a preset minimum prediction time, and a preset weight parameter of the first vehicle, wherein the minimum prediction time is less than the maximum prediction time. The vehicle control center calculates a product of the weight parameter and the minimum prediction time to obtain a weighted value, and then calculates a sum of the weighted value and the initial prediction time to obtain the intermediate prediction time. Finally, the vehicle control center determines a smaller one of the intermediate prediction time and the maximum prediction time as the prediction time. That is, when it is determined that the intermediate prediction time is less than the maximum prediction time, the intermediate prediction time is determined as the prediction time. When it is determined that the intermediate prediction time is greater than the maximum prediction time, the maximum prediction time is determined as the prediction time. Of course, if the intermediate prediction time is equal to the maximum prediction time, the vehicle control center may determine the intermediate prediction time or the maximum prediction time as the prediction time.

Of course, the vehicle control center may also use other methods to correct the initial prediction time so as to obtain the prediction time. The specific method may be selected as needed, and the present application does not limit it here.

The implementations of steps S201 to S203 are the same as the steps S101 to S103 in the above embodiments, and will not be described in detail here for brevity.

In the above manner, the vehicle control center may correct the results obtained according to the target speed parameter and the target distance parameter to determine the prediction time for adjusting the vehicle-following state more accurately.

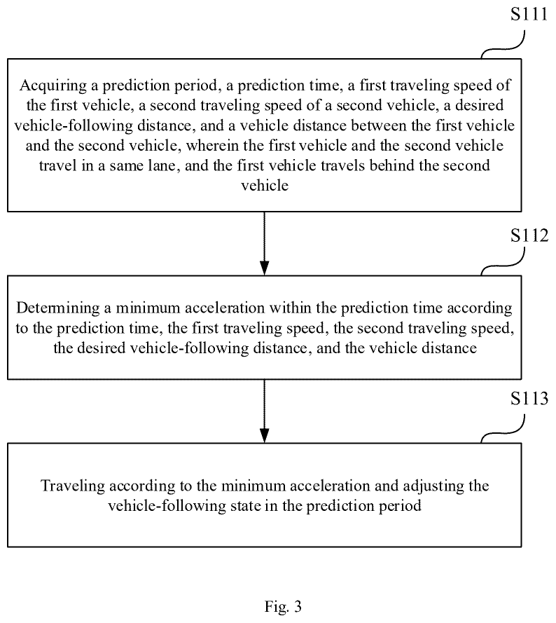

Based on the prediction time for adjusting the vehicle-following state, FIG. 3 is a flow chart of a method for adjusting a vehicle-following state according to an embodiment of the present application. As shown in FIG. 3, the vehicle-following state adjustment method according to the embodiment of the present application includes the following steps: S111 to S113.

In S111, a prediction period, a prediction time, a first traveling speed of the first vehicle, a second traveling speed of a second vehicle, a desired vehicle-following distance, and a vehicle distance between the first vehicle and the second vehicle are acquired, wherein the first vehicle and the second vehicle travel in a same lane, and the first vehicle travels behind the second vehicle.

In the present application, the method for adjusting the vehicle-following state may be executed by a vehicle control center of the first vehicle, or may be executed by a device such as a cloud server connected to the first vehicle. The device which executes the aforesaid method may be set as necessary and is not limited in the present application. In one or more embodiments of the present application, for convenience of description, the method for adjusting the vehicle-following state is described in detail by taking the method being executed by the vehicle control center as an example.

Normally, the vehicle will greatly accelerate/decelerate at an initial stage of adjusting the vehicle-following state, thereby quickly controlling the distance between the vehicle and the preceding vehicle. Accordingly, in one or more embodiments of the present application, the vehicle control center may also determine a minimum acceleration to achieve a substantial deceleration at the initial stage of adjusting the vehicle-following state, thereby reducing the possibility of reversing.

Specifically, in one or more embodiments of the present application, the vehicle control center may acquire a prediction time, a first traveling speed of a first vehicle, a second traveling speed of a second vehicle, a desired vehicle-following distance, a vehicle distance between the first vehicle and the second vehicle, and a preset prediction period. The first vehicle and the second vehicle travel in a same lane, and the first vehicle travels behind the second vehicle.

It should be noted that, the first traveling speed of the first vehicle may be acquired by a speed sensor disposed in the first vehicle. The second traveling speed of the second vehicle and the vehicle distance between the first vehicle and the second vehicle may be acquired by a device such as a radar or an image sensor disposed in the first vehicle. The specific device which acquires the first traveling speed, the second traveling speed, and the vehicle distance between the first vehicle and the second vehicle may be set as necessary and is not limited in the present application. Further, the desired vehicle-following distance may be set in advance. For example, the desired vehicle-following distance may be set in advance to 50 m, 80 m, or 100 m. The safe distance corresponding to the second traveling speed may be set as the desired vehicle-following distance. For example, if the second traveling speed is 100 km/h and the corresponding safe distance is 100 m, then the desired vehicle-following distance is determined as 100 m; or if the second traveling speed is 20 km/h and the corresponding safe distance is 30 m, then the desired vehicle-following distance is determined as 30 m. The desired vehicle-following distance may be set as necessary and is not limited in the present application. The prediction time is the time required for adjusting the vehicle-following state. For example, when the first traveling speed of the first vehicle is 80 km/h, the second traveling speed of the second vehicle is 80 km/h, the vehicle distance is 20 m, the desired vehicle-following distance is 80 m, and it is expected that the vehicle distance between the first vehicle and the second vehicle is 80 m and the first traveling speed is 80 km/h after 11 s, then the prediction time is 30 s. The prediction time may be set in advance, or may be calculated based on data such as the first traveling speed and the second traveling speed. The prediction time may be determined as needed, and the present application does not limit it here.

In the above manner, the vehicle control center may acquire data such as the first traveling speed and the second traveling speed, and determine the traveling acceleration of the first vehicle based on the data such as the first traveling speed and the second traveling speed, so as to adjust the vehicle-following state of the first vehicle.

In S112, a minimum acceleration within the prediction time is determined according to the prediction time, the first traveling speed, the second traveling speed, the desired vehicle-following distance, and the vehicle distance.

In one or more embodiments of the present application, to reduce the first traveling speed, increase the distance between the first vehicle and the second vehicle, and reduce the possibility that the vehicle control center enables the first vehicle to reverse to increase the distance at the initial stage of adjusting the vehicle-following state, the minimum acceleration of the first vehicle in the process of adjusting the vehicle-following state within the prediction time may be calculated.

Specifically, in one or more embodiments of the present application, first, the vehicle control center may calculate a prediction acceleration curve of the first vehicle in the process of adjusting the vehicle-following state within the prediction time according to the prediction time, the first traveling speed, the second traveling speed, the desired vehicle-following distance, and the vehicle distance. Since there is a relatively mature calculation method for calculating the prediction acceleration curve in the prior art, the present application will not repeat it here for brevity.

Of course, the vehicle control center may also acquire the acceleration of the first vehicle and a jerk of the first vehicle, and calculate the prediction acceleration curve of the first vehicle for adjusting the vehicle-following state within the prediction time according to the prediction time, the first traveling speed, the acceleration of the first vehicle, the jerk of the first vehicle, the second traveling speed, the desired vehicle-following distance, and the vehicle distance to determine the current state of the first vehicle more accurately, whereby the prediction acceleration curve is calculated more accurately.

Second, the vehicle control center may set a minimum acceleration value within the prediction time in the prediction acceleration curve as a minimum acceleration within the prediction time.

According to the above method, the vehicle control center may determine the minimum acceleration of the first vehicle in the prediction time by using the calculated prediction acceleration curve in the process of adjusting the vehicle-following state of the first vehicle in the prediction time, so that the traveling speed is adjusted according to the minimum acceleration in the subsequent step to adjust the vehicle-following state.

In S113, traveling according to the minimum acceleration and adjusting the vehicle-following state in the prediction period.

In one or more embodiments of the present application, after determining the minimum acceleration, the vehicle control center can adjust the traveling speed according to the minimum acceleration within the prediction period, thereby adjusting the vehicle-following state. The vehicle control center can realize a substantial deceleration at the initial stage of adjusting the vehicle-following state, increase the vehicle distance between the first vehicle and the second vehicle, and reduce the possibility that the vehicle control center enables the first vehicle to reverse to increase the vehicle distance.

Specifically, the vehicle control center may control the first vehicle to adjust the traveling speed according to the minimum acceleration and travel within the prediction period, thereby adjusting the vehicle-following state.

According to the above method, the vehicle control center can realize a substantial deceleration at the initial stage of adjusting the vehicle-following state, increase the vehicle distance between the first vehicle and the second vehicle, and reduce the possibility that the vehicle control center enables the first vehicle to reverse to increase the vehicle distance. Further, according to the above method, the first traveling speed of the first vehicle is greatly reduced at the initial stage of adjusting the vehicle-following state, which conforms to the operation of the user for adjusting the vehicle-following state, and improves the user experience.

Since the adjustment of the vehicle-following state may not be completed at the end of the prediction period, the present application further provides another implementation of the method for adjusting the vehicle-following state in the following embodiments.

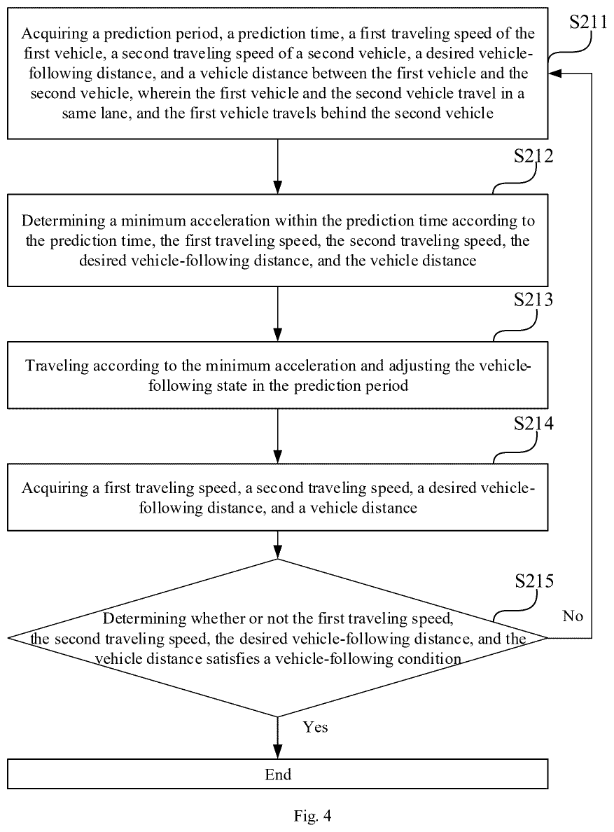

Referring to FIG. 4, another implementation of the method for adjusting the vehicle-following state according to the present application includes the following steps.

In step S211, a prediction period, a prediction time, a first traveling speed of the first vehicle, a second traveling speed of a second vehicle, a desired vehicle-following distance, and a vehicle distance between the first vehicle and the second vehicle are acquired, wherein the first vehicle and the second vehicle travel in a same lane, and the first vehicle travels behind the second vehicle.

In S212, a minimum acceleration within the prediction time is determined according to the prediction time, the first traveling speed, the second traveling speed, the desired vehicle-following distance, and the vehicle distance.

In S213, traveling according to the minimum acceleration and adjusting the vehicle-following state in the prediction period.

In S214, a first traveling speed, a second traveling speed, a desired vehicle-following distance, and a vehicle distance are acquired.

Specifically, the vehicle control center may reacquire a first traveling speed of the first vehicle, a second traveling speed of the second vehicle, a desired vehicle-following distance, and a vehicle distance between the first vehicle and the second vehicle to determine whether the first vehicle has completed the adjustment of the vehicle-following state.

In S215, it is determined whether or not the first traveling speed, the second traveling speed, the desired vehicle-following distance, and the vehicle distance satisfy the vehicle-following condition, if yes, the process ends, and if not, the process returns to step S211.

Specifically, the vehicle control center of the first vehicle may determine whether or not the vehicle-following condition is satisfied based on the reacquired first traveling speed, the second traveling speed, the desired vehicle-following distance, and the vehicle distance. If yes, the process ends, and the adjustment of the vehicle-following state of the first vehicle is completed. If not, the process returns to step S211.

The vehicle-following condition may be that the first traveling speed is equal to the second traveling speed, and the desired vehicle-following distance is equal to the vehicle distance; or the vehicle-following condition may also be a ratio of the first traveling speed to the second traveling speed falls in a preset first ratio interval (0.9 to 1.1), and a ratio of the vehicle distance to the desired vehicle-following distance falls in a preset second ratio interval (0.95 to 1.05). The vehicle-following condition may be set as other conditions. That is, the vehicle-following condition may be determined as needed, and the present application does not limit it here.

The implementations of steps S211 to S213 are the same as the steps S111 to S113 in the above embodiments, and will not be described in detail here for brevity.

According to the above implementation, when the adjustment of the vehicle-following state of the first vehicle is not completed after the end of the single prediction period, the vehicle control center may re-determine the minimum acceleration, and continue to adjust the vehicle-following state of the first vehicle according to the re-determined minimum acceleration.

To more accurately determine the minimum acceleration of the first vehicle in the prediction period and improve the efficiency of adjusting the vehicle-following state of the first vehicle, the present application further provides another implementation for adjusting the vehicle-following state in the following embodiments.

Another implementation for adjusting the vehicle-following state according to the present application includes the following steps.

In S301, a prediction period, a prediction time, a first traveling speed of the first vehicle, a second traveling speed of a second vehicle, a desired vehicle-following distance, and a vehicle distance between the first vehicle and the second vehicle are acquired, wherein the first vehicle and the second vehicle travel in a same lane, and the first vehicle travels behind the second vehicle.

In S302, a minimum acceleration within the prediction time is determined according to the prediction time, the first traveling speed, the second traveling speed, the desired vehicle-following distance, and the vehicle distance.

Specifically, in one or more embodiments of the present application, the vehicle control center may first acquire a preset dividing parameter.

Second, the vehicle control center may divide the prediction time into several prediction sub-times according to the dividing parameter. The vehicle control center may randomly divide the prediction time into several prediction sub-times according to the dividing parameter, and a duration of each prediction sub-time may be equal to a duration of at least one prediction sub-time among other prediction sub-times, or may be unequal to a duration of other prediction sub-times. The vehicle control center may also divide the prediction time into several prediction sub-times of equal duration according to the dividing parameter. The prediction time may be divided according to the dividing parameter as needed, and the present application does not limit it here.

Third, the vehicle control center may calculate a sub-acceleration corresponding to each of the several prediction sub-times according to the prediction time, the first traveling speed, the second traveling speed, the desired vehicle-following distance, and the vehicle distance.

The vehicle control center may determine a prediction acceleration curve corresponding to the prediction time according to the prediction time, the first traveling speed, the second traveling speed, the desired vehicle-following distance, and the vehicle distance. The vehicle control center then determines, for each of the prediction sub-times, a sub-acceleration curve corresponding to the prediction sub-time from the prediction acceleration curve corresponding to the prediction time, and determines a minimum value of the sub-acceleration curve as the sub-acceleration corresponding to the prediction sub-time.

The vehicle control center may determine a first prediction sub-time, a second prediction sub-time, a third prediction sub-time, and the like from the plurality of prediction sub-times in order of time. The vehicle control center then determines a first acceleration curve corresponding to the first prediction sub-time and vehicle-following data at the end of the first prediction sub-time according to the first prediction sub-time, the first traveling speed, the second traveling speed, the desired vehicle-following distance, and the vehicle distance. Simultaneously, the vehicle control center determines a minimum acceleration value in the first acceleration curve as a sub-acceleration corresponding to the first prediction sub-time. The vehicle-following data includes a real-time vehicle distance, a real-time first traveling speed, and a real-time second traveling speed.

The vehicle control center then determines a second acceleration curve corresponding to the second prediction sub-time and vehicle-following data at the end of the second prediction sub-time according to the vehicle distance and the second prediction sub-time. Simultaneously, the vehicle control center determines a minimum acceleration value in the second acceleration curve as a sub-acceleration corresponding to the second prediction sub-time. The vehicle control center then determines a third acceleration curve corresponding to the third prediction sub-time and vehicle-following data at the end of the third prediction sub-time according to the vehicle distance at the end of the second prediction sub-time and the third prediction sub-time. Simultaneously, the vehicle control center determines a minimum acceleration value in the third acceleration curve as a sub-acceleration corresponding to the third prediction sub-time. In this manner, the sub-acceleration corresponding to each of the several prediction sub-times can be determined.

Finally, the vehicle control center may determine a minimum sub-acceleration from the several determined sub-accelerations as a minimum acceleration within the prediction time.

In S303, driving according to the minimum acceleration and adjusting the vehicle-following state in the prediction period.

Step S301 is the same as step S111 in the above embodiment, and step S303 is the same as step S113 in the above embodiment, which will not be described in detail here for brevity.

According to the above method, the vehicle control center can more accurately determine the minimum acceleration of the first vehicle in the prediction period, and improve the efficiency of adjusting the vehicle-following state of the first vehicle.

In order to further reduce the possibility of reversing of the first vehicle, the present application further provides another implementation for adjusting the vehicle-following state in the following embodiments.

Another implementation for adjusting the vehicle-following state according to the present application includes the following steps.

In S401, a prediction period, a prediction time, a first traveling speed of the first vehicle, a second traveling speed of a second vehicle, a desired vehicle-following distance, and a vehicle distance between the first vehicle and the second vehicle are acquired, wherein the first vehicle and the second vehicle travel in a same lane, and the first vehicle travels behind the second vehicle.

In S402, a minimum acceleration within the prediction time is determined according to the prediction time, the first traveling speed, the second traveling speed, the desired vehicle-following distance, and the vehicle distance.

Specifically, in one or more embodiments of the present application, the vehicle control center may first calculate a prediction acceleration curve and a prediction speed curve in the process of adjusting the vehicle-following state of the first vehicle within the prediction time according to the prediction time, the first traveling speed, the second traveling speed, the desired vehicle-following distance, and the vehicle distance.

When it is determined that there are several coordinate points whose speed is less than 0 in the prediction speed curve, the coordinate time corresponding to the coordinate points whose speed is equal to 0 in the prediction speed curve is determined, the prediction time is re-determined according to the coordinate time, and the second traveling speed is determined as 0. The vehicle control center then calculates a prediction acceleration curve in the process of adjusting the vehicle-following state of the first vehicle within the prediction time according to the re-determined prediction time, the second traveling speed, the first traveling speed, the desired vehicle-following distance, and the vehicle distance. The vehicle control center determines a minimum acceleration value in the prediction acceleration curve as a minimum acceleration in the prediction time.

When it is determined that there is no coordinate point whose speed is less than 0 in the prediction speed curve, the vehicle control center determines a minimum acceleration value in the prediction acceleration curve as a minimum acceleration in the prediction time.

In S403, driving according to the minimum acceleration and adjusting the vehicle-following state in the prediction period.

Step S401 is the same as step S111 in the above embodiment, and step S403 is the same as step S113 in the above embodiment, which will not be described in detail here for brevity.

According to the above method, the vehicle control center can further reduce the possibility of reverse of the first vehicle.

Based on the prediction time determination method for adjusting the vehicle-following state according to the above embodiment, accordingly, the present application further provides a specific implementation of a prediction time determination apparatus for adjusting the vehicle-following state. Please see the following examples.

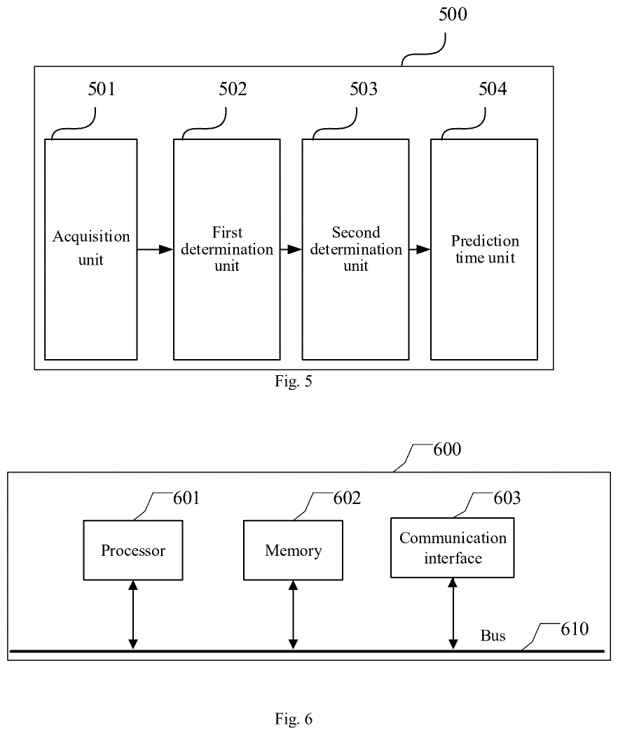

First, referring to FIG. 5, the prediction time determination apparatus 500 for adjusting the vehicle-following state according to an embodiment of the present application includes the following units.

An acquisition unit 501 is configured to acquire a desired vehicle-following distance, a first traveling speed of the first vehicle, a second traveling speed of a second vehicle, and a vehicle distance between the first vehicle and the second vehicle, wherein the first vehicle and the second vehicle travel in a same lane, and the first vehicle travels behind the second vehicle.

A first determination unit 502 is configured to determine a target speed parameter according to the first traveling speed and the second traveling speed.

A second determination unit 503 is configured to determine a target distance parameter according to the desired vehicle-following distance and the vehicle distance.

A prediction time unit 504 is configured to determine a prediction time according to the target speed parameter and the target distance parameter.

It can be seen from the above apparatus 500 that, the acquisition unit 501 acquires parameters such as the first traveling speed and the second traveling speed, and then the first determination unit determines the target speed parameter characterizing a difference between the first traveling speed and the second traveling speed, and the second determination unit determines the target distance parameter characterizing a difference between the vehicle distance and the desired vehicle-following distance. Finally, the prediction time unit determines the time for adjusting the vehicle-following state according to the target speed parameter and the target distance parameter.

As an implementation of the present application, in order to more accurately determine the target speed parameter, the apparatus may further include a first determination sub-unit.

The first determination sub-unit is configured to determine a relative speed according to the first traveling speed and the second traveling speed, calculate a ratio of the relative speed to the first traveling speed, and obtain a target speed parameter.

As another implementation of the present application, in order to more accurately determine the target speed parameter, the apparatus may further include a second determination sub-unit.

The second determination sub-unit is configured to determine a relative distance according to the desired vehicle-following distance and the vehicle distance, calculate a ratio of the vehicle distance to the desired vehicle-following distance, and obtain the target distance parameter.

As another implementation of the present application, in order to more accurately determine the target speed parameter, the apparatus may further include a prediction time sub-unit.

The prediction time sub-unit is configured to determine an initial prediction time according to the target speed parameter and the target distance parameter, and correct the initial prediction time to obtain the prediction time.

As another implementation of the present application, in order to more accurately determine the target speed parameter, the apparatus may further include a prediction time sub-unit.

The prediction time sub-unit is configured to acquire a maximum prediction time and a minimum prediction time of the first vehicle, determine an intermediate prediction time according to the minimum prediction time and the initial prediction time, and determine a smaller one of the intermediate prediction time and the maximum prediction time as the prediction time.

As another implementation of the present application, in order to more accurately determine the target speed parameter, the apparatus may further include a prediction time sub-unit.

The prediction time sub-unit is configured to acquire a preset weight parameter, determine a product of the minimum prediction time and the weight parameter as a weighted value, and determine a sum of the weighted value and the initial prediction time as an intermediate prediction time.

As another implementation of the present application, the prediction time determination apparatus for adjusting the vehicle-following state further includes a traveling unit.

An acquisition unit is further configured to acquire a prediction period, a prediction time, a first traveling speed of the first vehicle, a second traveling speed of a second vehicle, a desired vehicle-following distance, and a vehicle distance between the first vehicle and the second vehicle, wherein the first vehicle and the second vehicle travel in a same lane, and the first vehicle travels behind the second vehicle.

A third determination unit is configured to determine a minimum acceleration within the prediction time according to the prediction time, the first traveling speed, the second traveling speed, the desired vehicle-following distance, and the vehicle distance.

The traveling unit is configured to travel according to the minimum acceleration and adjust the vehicle-following state in the prediction period.

According to the embodiment of the present application, it can be seen that, the traveling unit can enable the first vehicle to travel at the minimum acceleration. The minimum acceleration is the minimum acceleration within the prediction time determined by the acquisition unit and the third determination unit based on data such as the vehicle distance and the desired vehicle-following distance. When travels at the minimum acceleration, the first vehicle can reduce the first traveling speed significantly, so as to increase the vehicle distance and reduce the possibility of reversing. Additionally, significantly reducing the first traveling speed during the initial stage of adjusting the vehicle-following state conforms to the driving habits of most users. Therefore, the user experience can be improved by the above method.

As an implementation of the present application, in order to perform the adjustment of the vehicle-following state of the first vehicle, the traveling unit may specifically include a traveling sub-unit.

The traveling sub-unit is configured to acquire a first traveling speed, a second traveling speed, a desired vehicle-following distance, and a vehicle distance, and return back to the step of acquiring a prediction period, a prediction time, a first traveling speed of the first vehicle, a second traveling speed of a second vehicle, a desired vehicle-following distance, and a vehicle distance between the first vehicle and the second vehicle when it is determined that a vehicle-following condition is not satisfied according to the first traveling speed, the second traveling speed, the desired vehicle-following distance, and the vehicle distance.

As an implementation of the present application, in order to perform the adjustment of the vehicle-following state of the first vehicle, the traveling unit may specifically include a traveling sub-unit.

The traveling sub-unit is configured to enable the first traveling speed being equal to the second traveling speed, and the desired vehicle-following distance being equal to the vehicle distance.

As an implementation of the present application, in order to more accurately determine the minimum acceleration, the third determination unit may specifically include a third determination sub-unit.

The third determination sub-unit is configured to divide the prediction time into several prediction sub-times; determine sub-accelerations corresponding to the several prediction sub-times respectively according to the prediction time, the first traveling speed, the second traveling speed, the desired vehicle-following distance, and the vehicle distance; and determine a smallest sub-acceleration among several sub-accelerations as the minimum acceleration within the prediction time.

As an implementation of the present application, in order to more accurately determine the minimum acceleration, the third determination unit may specifically include a third determination sub-unit.

The third determination sub-unit is configured to enable the several prediction sub-times being all equal to each other in duration.

As an implementation of the present application, in order to more accurately determine the minimum acceleration, the third determination unit may specifically include a third determination sub-unit.

The third determination sub-unit is configured to determine a prediction acceleration curve corresponding to the prediction time according to the prediction time, the first traveling speed, the second traveling speed, the desired vehicle-following distance, and the vehicle distance; determine, for each of the prediction sub-times, a sub-acceleration curve of the prediction acceleration curve corresponding to the prediction sub-time; and determine a minimum value of the sub-acceleration curve as the sub-acceleration corresponding to the prediction sub-time.

FIG. 6 is a hardware structural diagram of a prediction time determination device for adjusting a vehicle-following state according to an embodiment of the present application.

The prediction time determination device for adjusting the vehicle-following state may include a processor 601 and a memory 602 storing computer program instructions.

Specifically, the processor 601 may include a central processing unit (CPU), or an Application Specific Integrated Circuit (ASIC), or may be configured as one or more integrated circuits for implementing the embodiments of the present application.

The memory 602 may include mass memory for data or instructions. By way of example but not limitation, the memory 602 may include a Hard Disk Drive (HDD), a floppy disk drive, a flash memory, an optical disk, a magneto-optical disk, a magnetic tape, or a Universal Serial Bus (USB) drive, or a combination of two or more thereof. The memory 602 may include removable or non-removable (or fixed) media, as appropriate. The memory 602 may be provided internal or external to the integrated gateway disaster tolerance device, as appropriate. In a particular embodiment, the memory 602 is a non-volatile solid-state memory.

In particular embodiments, the memory may include read-only memory (ROM), random access memory (RAM), magnetic disk storage media devices, optical storage media devices, flash memory devices, electrical, optical, or other physical/tangible memory storage devices. Thus, in general, the memory includes one or more tangible (non-transitory) computer-readable storage media (e.g. memory devices) having data embodied in software comprising computer-executable instructions, and the software, when being executed (e.g. by one or more processors), is operable to perform the operations described in the methods according to embodiments of the present application.

The processor 601 implements any one of the prediction time determination method for adjusting the vehicle-following state of the above-mentioned embodiments by reading and executing computer program instructions stored in the memory 602.

In one example, the prediction time determination device for adjusting the vehicle-following state may further include a communication interface 603 and a bus 610. As shown in FIG. 6, the processor 601, the memory 602, and the communication interface 603 are connected to each other via the bus 610, and communicate with each other thereby.

The communication interface 603 is mainly used for realizing communication between modules, apparatus, units, and/or devices in the embodiments of the present application.

The bus 610 includes hardware, software, or both thereof, for coupling components of the prediction time determination device for adjusting the vehicle-following state to each other. By way of example but not limitation, the bus may include an accelerated graphics port (AGP) or other graphics bus, an enhanced industry standard architecture (EISA) bus, a front side bus (FSB), a Hyper Transport (HT) interconnect, an industry standard architecture (ISA) bus, an infinite bandwidth interconnect, a low pin count (LPC) bus, a memory bus, a micro channel architecture (MCA) bus, a peripheral component interconnect (PCI) bus, a PCI-Express (PCI-X) bus, a serial advanced technology attachment (SATA) bus, a video electronics standards association local (VLB) bus, or other suitable bus, or a combination of two or more thereof. The bus 610 may include one or more buses, as appropriate. Although embodiments of the present application describe and illustrate particular buses, any suitable bus or interconnect is contemplated by the present application.

The prediction time determination device for adjusting the vehicle-following state may implement the prediction time determination method for adjusting the vehicle-following state in the embodiments of the present application, whereby the technical effects of the prediction time determination method for adjusting the vehicle-following state or the method for adjusting the vehicle-following state in the embodiments of the present application can be achieved.

In addition, the embodiments of the present application further provide a computer storage medium for implementing the prediction time determination method for adjusting the vehicle-following state or the method for adjusting the vehicle-following state of the above embodiments. The computer storage medium has stored thereon computer program instructions which, when executed by a processor, implement the prediction time determination method for adjusting the vehicle-following state or the method for adjusting the vehicle-following state according to any one of the above embodiments.

It should be noted that, this application is not limited to the specific configurations and processes described above and illustrated in the drawings. For the sake of brevity, a detailed description of known methods is omitted here. In the embodiments described above, a number of specific steps have been described and shown as examples. However, the method processes of the present application are not limited to the specific steps described and illustrated herein, and those skilled in the art can make various changes, modifications, and additions, or change the order between steps, after understanding the gist of the present application.

The functional blocks shown in the block diagrams described above may be implemented in hardware, software, firmware, or a combination thereof. When implemented in hardware, it may be, for example, an electronic circuit, an application specific integrated circuit (ASIC), appropriate firmware, a plug-in, a function card, and so on. When implemented in software, the elements of the present application are programs or code segments used to perform the required tasks. The programs or code segments may be stored in a machine-readable medium or transmitted over a transmission medium or communication link by a data signal carried in a carrier wave. The “machine-readable medium” may include any medium that can store or transmit information. Examples of the machine-readable medium include an electronic circuit, a semiconductor memory device, an ROM, a flash memory, an erasable ROM (EROM), a floppy disk, a CD-ROM, an optical disk, a hard disk, an optical fiber medium, a radio frequency (RF) link, and so on. The code segments may be downloaded via a computer network, such as the Internet, an intranet, or the like.

It should also be noted that, the exemplary embodiments mentioned in this application describe methods or systems based on a series of steps or apparatus. However, the present application is not limited to the order of the steps described above, that is, the steps may be performed in the order mentioned in the embodiments, or may be performed in an order different from that in the embodiments, or several steps may be performed simultaneously.

Aspects of the present disclosure are described above with reference to flow charts and/or block diagrams of methods, apparatus (systems) and computer program products according to embodiments of the disclosure. It will be understood that, each block in the flow charts and/or block diagrams, and a combination of any of blocks in the flow charts and/or block diagrams, may be implemented by computer program instructions. These computer program instructions may be provided to a processor of a general purpose computer, a special purpose computer, or other programmable data processing apparatus to produce a machine, such that the instructions, which being executed via the processor of the computer or other programmable data processing apparatus, enable the implementation of the functions/actions specified in one or more blocks in the flow charts and/or block diagrams. Such a processor may be, but is not limited to, a general purpose processor, a special purpose processor, an application specific processor, or field programmable logic circuit. It should also be understood that, each block in the block diagrams and/or flow charts, and a combination of any of blocks in the block diagrams and/or flow charts, may also be implemented by a special purpose hardware that performs the specified functions or actions, or a combination of special purpose hardware and computer instructions.

The above are only specific implementations of the present application, those skilled in the art can clearly understand that, for the convenience and brevity of the description, the specific working processes of the above-described systems, modules and controllers can be referred to the corresponding processes in the foregoing method embodiments, which is not repeated here. It should be understood that, the protection scope of this application is not limited to this, and any person skilled in the art can easily think of various equivalent modifications or replacements within the technical scope disclosed in this application, and these modifications or replacements should all be covered within the scope of protection of this application.

1. A prediction time determination method for adjusting a vehicle-following state, applied to a first vehicle, the method comprising:
acquiring a desired vehicle-following distance, a first traveling speed of the first vehicle, a second traveling speed of a second vehicle, and a vehicle distance between the first vehicle and the second vehicle, wherein the first vehicle and the second vehicle travel in a same lane, and the first vehicle travels behind the second vehicle;
determining a target speed parameter according to the first traveling speed and the second traveling speed;
determining a target distance parameter according to the desired vehicle-following distance and the vehicle distance; and
determining a prediction time according to the target speed parameter and the target distance parameter.

2. The method according to claim 1, wherein the determining a target speed parameter according to the first traveling speed and the second traveling speed comprises:
determining a relative speed according to the first traveling speed and the second traveling speed; and
calculating a ratio of the relative speed to the first traveling speed to obtain the target speed parameter.

3. The method according to claim 1, wherein the determining a target distance parameter according to the desired vehicle-following distance and the vehicle distance comprises:
determining a relative distance according to the desired vehicle-following distance and the vehicle distance; and
calculating a ratio of the vehicle distance to the desired vehicle-following distance to obtain the target distance parameter.

4. The method according to claim 1, wherein the determining a prediction time according to the target speed parameter and the target distance parameter specifically comprises:
determining an initial prediction time according to the target speed parameter and the target distance parameter; and
correcting the initial prediction time to obtain the prediction time.

5. The method according to claim 4, wherein the correcting the initial prediction time to obtain the prediction time specifically comprises:
acquiring a maximum prediction time and a minimum prediction time of the first vehicle;
determining an intermediate prediction time according to the minimum prediction time and the initial prediction time; and
determining a smaller one of the intermediate prediction time and the maximum prediction time as the prediction time.

6. The method according to claim 5, wherein the determining an intermediate prediction time according to the minimum prediction time and the initial prediction time specifically comprises:
acquiring a preset weight parameter;
determining a product of the minimum prediction time and the weight parameter as a weighted value; and
determining a sum of the weighted value and the initial prediction time as the intermediate prediction time.

7. The method according to claim 1, wherein, after the determining a prediction time according to the target speed parameter and the target distance parameter, the method further comprises:
acquiring a prediction period, a prediction time, a first traveling speed of the first vehicle, a second traveling speed of a second vehicle, a desired vehicle-following distance, and a vehicle distance between the first vehicle and the second vehicle;
determining a minimum acceleration within the prediction time according to the prediction time, the first traveling speed, the second traveling speed, the desired vehicle-following distance, and the vehicle distance; and
traveling according to the minimum acceleration and adjusting the vehicle-following state in the prediction period.

8. The method according to claim 7, wherein, after the adjusting the vehicle-following state, the method further comprises:
acquiring a first traveling speed, a second traveling speed, a desired vehicle-following distance, and a vehicle distance; and
returning back to the step of acquiring a prediction period, a prediction time, a first traveling speed of the first vehicle, a second traveling speed of a second vehicle, a desired vehicle-following distance, and a vehicle distance between the first vehicle and the second vehicle when it is determined that a vehicle-following condition is not satisfied according to the first traveling speed, the second traveling speed, the desired vehicle-following distance, and the vehicle distance.

9. The method according to claim 8, wherein the vehicle-following condition comprises: the first traveling speed being equal to the second traveling speed, and the desired vehicle-following distance being equal to the vehicle distance.

10. The method according to claim 7, wherein the determining a minimum acceleration within the prediction time according to the prediction time, the first traveling speed, the second traveling speed, the desired vehicle-following distance, and the vehicle distance specifically comprises:
dividing the prediction time into several prediction sub-times;
determining sub-accelerations corresponding to the several prediction sub-times respectively according to the prediction time, the first traveling speed, the second traveling speed, the desired vehicle-following distance, and the vehicle distance; and
determining a smallest sub-acceleration among several sub-accelerations as the minimum acceleration within the prediction time.

11. The method according to claim 10, wherein the several prediction sub-times are equal to each other in duration.

12. The method according to claim 10, wherein the determining sub-accelerations corresponding to the several prediction sub-times respectively according to the prediction time, the first traveling speed, the second traveling speed, the desired vehicle-following distance, and the vehicle distance specifically comprises:
determining a prediction acceleration curve corresponding to the prediction time according to the prediction time, the first traveling speed, the second traveling speed, the desired vehicle-following distance, and the vehicle distance;
determining, for each of the prediction sub-times, a sub-acceleration curve of the prediction acceleration curve corresponding to the prediction sub-time; and
determining a minimum value of the sub-acceleration curve as the sub-acceleration corresponding to the prediction sub-time.

13. A prediction time determination apparatus for adjusting a vehicle-following state applied to a first vehicle, the apparatus comprising:
an acquisition unit configured to acquire a desired vehicle-following distance, a first traveling speed of the first vehicle, a second traveling speed of a second vehicle, and a vehicle distance between the first vehicle and the second vehicle, wherein the first vehicle and the second vehicle travel in a same lane, and the first vehicle travels behind the second vehicle;
a first determination unit configured to determine a target speed parameter according to the first traveling speed and the second traveling speed;
a second determination unit configured to determine a target distance parameter according to the desired vehicle-following distance and the vehicle distance; and
a prediction time unit configured to determine a prediction time according to the target speed parameter and the target distance parameter.

14. A prediction time determination device for adjusting a vehicle-following state, the device comprising a processor and a memory storing computer program instructions, wherein the computer program instructions, when executed by the processor, implement the prediction time determination method for adjusting a vehicle-following state according to claim 1.

15. A non-transitory computer readable storage medium having stored thereon computer program instructions which, when executed by a processor, implement the prediction time determination method for adjusting a vehicle-following state according to claim 1.

16. A computer program product, wherein when instructions in the computer program product are executed by a processor of an electronic device, enables the electronic device to implement the prediction time determination method for adjusting a vehicle-following state according to claim 1.

17. A vehicle, comprising the prediction time determination apparatus for adjusting vehicle-following state according to claim 13.

18. A vehicle, comprising the prediction time determination device for adjusting vehicle-following state according to claim 14.

19. A vehicle, comprising the non-transitory computer readable storage medium according to claim 15.

20. A vehicle, comprising the computer program product according to claim 16.
